(19) United States
(12) Patent Application Publication
(10) Pub. No.: US 2015/0368858 A1
(43) Pub. Date: Dec. 24, 2015

(54) COATING SYSTEM

(71) Applicant: CARL FREUDENBERG KG, Weinheim (DE)

(72) Inventors: Ulrich SCHNEIDER, Darmstadt (DE); Michael ZAPLATILEK, Birkenau (DE); Hartwik von der MUEHLEN, Heidelberg (DE); Rudolf WAGNER, Muehlheim (DE); Michael APPELGRUEN, Voerstetten (DE)

(21) Appl. No.: 14/655,132

(22) PCT Filed: Jan. 9, 2014
(86) PCT No.: PCT/EP2014/000023

§ 371 Date: Jun. 24, 2015

(30) Foreign Application Priority Data
Jan. 11, 2013 (DE) 10 2013 000 333.4

(51) Int. Cl. D06N 3/00; B32B 5/02

(52) U.S. Cl. CPC D06N 3/0011; D06N 3/0038; D06N 3/0036; D06N 3/0034; B32B 5/022; B32B 2255/02; B32B 2255/26; B32B 2262/0253; B32B 2262/0261; B32B 2262/0284; B32B 2262/0276; B32B 2262/04; B32B 2262/12; B32B 2307/552; B32B 2307/712; B32B 2307/554

(57) ABSTRACT

A use of a nonwoven with a specific surface area, measured as specified by DIN ISO 9277, of at least 0.15 m², having fibers with a denier of less than 5 dtex in a quantity of at least 30 percent by weight, with reference to the total weight of the nonwoven, wherein the nonwoven contains at least one of the following hydrophilic components: (i) fibers with a surface energy, measured in accordance with DIN 55660, of >35 mN/m; (ii) at least one binder with a surface energy, measured in accordance with DIN 55660, of >35 mN/m; and/or (iii) at least one filler with a surface energy, measured in accordance with DIN 55660, of >35 mN/m, as a carrier material for the coating with an overlay, in particular a layer of lacquer, varnish or paint and/or a film.

### CROSS-REFERENCE TO RELATED APPLICATIONS

This application is a U.S. national stage application under 35 U.S.C. §371 of International Application No. PCT/EP2014/000023, filed on Jan. 9, 2014, and claims benefit to German Patent Application No. DE 10 2013 000 333.4, filed on Jan. 11, 2013. The International Application was published in German on Jul. 17, 2014, as WO 2014/108331 A1 under PCT Article 21(2).

### FIELD

The invention relates to the use of a non-woven as a carrier material for coating, in particular direct coating, with a cover, in particular a varnish and/or paint layer.

### BACKGROUND

Coating systems consisting of carrier materials and varnish or paint layers are in principle known. By applying systems of this type to surfaces, improved protection of the surface against mechanical loads, such as impact or bending, against damage due to wear, against crack formation due to temperature fluctuations and against corrosion upon contact with aggressive chemicals can be achieved.

Additionally, compared with direct application of varnish or paint layers, the use of coating systems has the advantage that these layers are already cured when applied to the surfaces to be protected. Thus, no solvents are released at the application site. Additionally, handling of the coated materials is simplified, since varnish and paint layers are usually very sensitive to for example impacts or impurities when not yet cured.

In the industry, papers are conventionally used as carrier materials, since they have good absorption, and high adhesion strengths can thus be achieved.

However, a drawback of the use of paper is that only papers having relatively high thickness and rigidity can be used, since only these papers have the required mechanical properties, such as sufficient strength. However, papers having high thickness and rigidity are unsuitable for forming structured surfaces and in particular small radii. Therefore, they often cannot be used if the coated carrier material is to be applied to a substrate having a structured surface.

Document WO 2012/074380 discloses a coating system in which a non-woven or a woven fabric is used as a substrate for direction application of coatings. Because of the higher stability and flexibility of the substrates as compared with paper, this coating system can also be used for coating materials having structured surfaces. In this document, there are no more detailed indications as to the nature of the non-woven or woven fabric to be used. Practical tests have shown that the varnish adhesion to the non-wovens conventionally used in the region of the surface coating, which are based on polyester, polyacrylonitrile and glass fibers, is unsatisfactory.

### SUMMARY

An aspect of the invention provides a multilayer, comprising a coating and a carrier material suitable for coating, the carrier material comprising a non-woven having a specific surface area of at least 0.15 m², wherein the non-woven comprises: first fibers having a titer of less than 5 dtex in an amount of at least 30 wt. %, based on a total weight of the non-woven; and a hydrophilic component comprising second fibers having a surface energy of >35 mN/m, a binder having a surface energy of >35 mN/m, a filler having a surface energy of >35 mN/m, or a mixture of two or more of any of these, wherein the specific surface area is measured in accordance with DIN ISO 9277, and wherein the surface energy is measured in accordance with DIN 55660.

### BRIEF DESCRIPTION OF THE DRAWINGS

The present invention will be described in even greater detail below based on the exemplary FIGURE. The invention is not limited to the exemplary embodiments. All features described and/or illustrated herein can be used alone or combined in different combinations in embodiments of the invention. The features and advantages of various embodiments of the present invention will become apparent by reading the following detailed description with reference to the attached drawing which illustrates the following:

FIG. 1 shows an example of a test arrangement.

### DETAILED DESCRIPTION

Relative to WO 2012/074380, an aspect of the invention is to provide a non-woven which is optimized as a carrier material for coating, in particular direct coating, with a cover, and which is distinguished in particular in that it has strong adhesion to a wide range of covers, in particular varnish and/or paint layers.

An aspect of the invention provides a use of a non-woven having a specific surface area, measured in accordance with DIN ISO 9277, of at least 0.15 m², comprising fibers having a titer of less than 5 dtex in an amount of at least 30 percent by weight based on the total weight of the non-woven, the non-woven containing at least one of the following hydrophilic components:
fibers having a surface energy, measured in accordance with DIN 55660, of >35 mN/m,
at least one binder having a surface energy, measured in accordance with DIN 55660, of >35 mN/m, and/or
at least one filler having a surface energy, measured in accordance with DIN 55660, of >35 mN/m
   as a carrier material for coating with a cover, in particular a varnish layer, paint layer and/or a film.

Surprisingly, in accordance with the invention it has been found that a non-woven which has the above features has excellent adhesion to a wide range of covers, in particular to varnish and/or paint layers. In accordance with the invention, the term “hydrophilic” means that the component in question has a surface energy, measured in accordance with DIN 55660, of >35 mN/m.

A wide range of fibers may be used as hydrophilic fibers. According to the invention, fibers which contain cellulose, viscose, Lyocell, polyester, in particular polyethyleneterephthalate or polybutyleneterephthalate, copolyester, (co)polyamide, in particular polyamide 6, polyamide 6,6, aliphatic and/or aromatic polyamides, polyphenylenesulphide, glass, basalt, polyurethane, polyimide, melamine resin, modacrylic and/or polyacrylonitrile are particularly suitable as long as they have a surface energy, measured in accordance with DIN 55660, of >35 mN/m.

If polyesters are used, aromatic polyesters are preferred, since they have better mechanical and thermal properties than aliphatic polyesters. Preferably, the fibers contain the aforementioned materials in an amount of 50-100 wt. %, more preferably 60-100 wt. %. Particularly preferably, the fibers consist of the aforementioned materials. If the fibers contain mixtures of the aforementioned materials, they may for example be in the form of blends and/or copolymers.

Fibers which contain cellulose, in particular hydrophilic natural fibers such as wood fibers, bast fibers, in particular hemp fibers, flax fibers, kenaf fibers, ramie fibers, jute fibers, sisal fibers, coconut fibers and/or cotton fibers, have been found to be particularly suitable.

In a preferred embodiment of the invention, the fibers contain a mixture of synthetic fibers and natural fibers. In this case, the natural fibers are preferably in a ground form, for example as fiber pulp. The proportion of synthetic fibers and natural fibers may vary depending on the desired property profile. Good results are generally achieved when the ratio of the amounts of natural and synthetic fibers is set between 9 to 1 and 1 to 9.

The proportion of hydrophilic fibers in the non-woven is preferably 20 wt. % to 100 wt. %, preferably 30 wt. % to 80 wt. %, based on the total weight of the non-woven. Expediently, the hydrophilic fibers, if present, form at least in part the proportion of fibers having a titer of less than 5 dtex provided in the non-woven according to the invention. According to the invention, the proportion of fibers having a titer of less than 5 dtex is less than 30 percent by weight based on the total weight of the non-woven. In a preferred embodiment of the invention, the proportion of fibers having a titer of less than 5 dtex is 50-100 wt. %, preferably 60-100 wt. %, based on the total weight of the non-woven.

A wide range of binders may be used as hydrophilic binders. According to the invention, binders selected from the group of acrylates, vinylacrylates, vinylacetates, ethylenevinylacetates (EVA), acrylonitrilebutadienes (NBR), styrenebutadienes (SBR), acrylonitrilebutadienestyrenes (ABS), vinylchlorides, ethylenevinylchlorides, polyvinylalcohols, polyurethanes, starch derivatives, cellulose derivatives and mixtures and/or copolymers thereof are particularly suitable as long as they have a surface energy, measured in accordance with DIN 55660, of >35 mN/m.

The proportion of hydrophilic binder in the non-woven is preferably 0-90 wt. %, more preferably 5-50 wt. %, more preferably 10-30 wt. %, more preferably 15-25 wt. %, based on the total weight of the non-woven.

A wide range of fillers may be used as the hydrophilic filler. According to the invention, fillers selected from the group consisting of carbonates, silicates, sulfates, borates, phosphates and metals and the oxides thereof, soots, glasses, polymer particles, ground fibers (synthetic and natural) and/or organic, inorganic pigments, colored pigments, (non-)ionic surfactants, UV stabilizers, biocides are particularly suitable as long as they have a surface energy, measured in accordance with DIN 55660, of >35 mN/m.

The proportion of hydrophilic fillers in the non-woven is preferably 0 to 90 wt. %, more preferably 5-50 wt. %, more preferably 10-30 wt. %, more preferably 15-25 wt. %.

According to the invention, the non-woven contains hydrophilic fibers, hydrophilic binders and/or hydrophilic fillers having a surface energy, measured in accordance with DIN 55660, of at least 35 mN/m. In a particularly preferred embodiment of the invention, the hydrophilic fibers, binders and/or fillers have a surface energy, measured in accordance with DIN 55660, of 35 mN/m to 300 mN/m, preferably 35 mN/m to 200 mN/m, more preferably 35 mN/m to 150 mN/m, and in particular 35 mN/m to 75 mN/m.

The non-woven used in the method according to the invention has a specific surface area, measured in accordance with DIN ISO 9277, of at least 0.15 m². Particularly good adhesive properties are obtained if the non-woven has a specific surface area, measured in accordance with DIN ISO 9277, of 0.15 m² to 1.5 m², more preferably 0.2 to 1.5 m² and in particular 0.25 to 1.5 m².

The hydrophilic fibers, binders and/or fillers may be distributed uniformly or non-uniformly in the non-woven as long as a sufficient amount of hydrophilic fibers and/or fillers is present on the surface, provided for the coating, of the non-woven. Preferably, the fibers, binders and/or fillers are distributed uniformly in the non-woven.

According to the invention, the use of hydrophilic fibers as a hydrophilic component is particularly preferred.

In accordance with the invention, the term “non-woven” is used in the conventional sense. Thus, a non-woven means a textile planar formation of fibers of finite or infinite length, which are chemically, thermally or mechanically interconnected. By contrast, woven fabrics, warp-knitted fabrics and weft-knitted fabrics are made of yarns and membranes are made of films.

The fibers used for producing the non-woven, in particular the hydrophilic fibers, may be staple fibers, which may have a length of 30 to 80 mm, preferably 30 to 70 mm, more preferably 30 to 60 mm, or be short-cut fibers and/or filaments. Preferably, short-cut fibers of a length of 1 mm to 30 mm, preferably 1 mm to 25 mm, in particular 1 mm to 20 mm, are used for producing the non-woven. The cross sections of the fibers used may have round, polygonal, lobed, ribbon-like, oval, hollow, step-index or other possible cross sections. The fibers may previously have undergone refining or grinding for further fibrillation. The use of fiber pulp is particularly preferred. In a particularly preferred embodiment of the invention, fiber pulp, optionally in combination with other short-cut fibers, is used to produce the non-woven. The proportion of fiber pulp in the fiber mixture and/or in the non-woven is preferably 10-70% by weight, more preferably 20-60% by weight, based on the total weight of the non-woven. In a particularly preferred embodiment of the invention, the Schopper-Riegler grinding level of the fiber pulp is 10-60° SR, preferably 10-50° SR.

An advantage of the use of staple fibers as a base material as compared with filaments is that it is possible to obtain non-wovens having a higher homogeneity. However, for the use according to the invention as a carrier material for coating with a cover, in particular a varnish layer, paint layer and/or a film, high homogeneity is important, since it makes a uniform coating result possible. In particular in varnish layers, a uniform coating result is of vital importance.

For producing the non-woven, further, non-hydrophilic fibers may also be used to form the fiber matrix, for example polyolefins, in particular aliphatic and/or aromatic polyolefins. These may be in the form of monofilaments or bicomponent fibers and have the same fiber length and/or fiber titer as the hydrophilic fibers. Preferably, the non-hydrophilic fibers are present in the non-woven in an amount of up to 40 wt. %, preferably 5-30 wt. %, based on the total weight of the non-woven.

It has also been found to be advantageous for the fibers, in particular the hydrophilic fibers, to have a low average diameter. Thus, particularly good adhesive strengths can be achieved using non-wovens having an average fiber diameter, measured in accordance with DIN 53811, of 0.1 to 25 μm, preferably 1 to 25 μm.

Particularly good results are achieved if the proportion of fibers, in particular of hydrophilic fibers, having an average fiber diameter, measured in accordance with DIN 53811, of 0.1 to 25 μm, preferably 1 to 25 μm, is at least 50 wt. %, preferably 80-100 wt. %, based on the total amount of fibers in the non-woven.

In a preferred embodiment of the invention, the non-woven is produced by chemical bonds, in particular by strengthening a non-woven using a binding agent. The binder may be applied by impregnation, painting, printing, splashing or spraying. As stated above, hydrophilic polymers, in particular acrylates, vinylacrylates, vinylacetates, ethylenevinylacetates (EVA), acrylonitrilebutadienes (NBR), styrenebutadienes (SBR), acrylonitrilebutadienestyrenes (ABS), vinylchlorides, ethylenevinylchlorides, polyvinylalcohols, polyurethanes, starch derivatives, cellulose derivatives and copolymers and/or mixtures thereof are preferably used as binders.

The use of the binder has the advantage that it can increase the hydrophilicity of the non-woven surface and thus the adhesive strength thereof. Further, the binder forms a barrier, which counters penetration of the cover material, for example a varnish or paint, into the non-woven.

In a further preferred embodiment of the invention, after production the non-woven is impregnated with a binder. As a result, penetration of the cover material into the non-woven can be countered even more effectively.

The binders used for the subsequent impregnation of the non-woven may be the same as those disclosed for strengthening the non-woven. However, other binders may also be used for this purpose. In total, it has been found that acrylates, vinylacrylates, vinylacetates, ethylenevinylacetates (EVA), acrylonitrilebutadienes (NBR), styrenebutadienes (SBR), acrylonitrilebutadienestyrenes (ABS), vinylchlorides, ethylenevinylchlorides, polyvinylalcohols, polyurethanes, starch derivatives, cellulose derivatives and copolymers and/or mixtures thereof are particularly suitable as regards the hydrophilicity and barrier function thereof.

The aforementioned binders are preferably used in the form of suspensions, which for example have solids contents of 5 wt. % to 60 wt. %, preferably 10 wt. % to 55 wt. %, more preferably 20 wt. % to 50 wt. %. The binders may be used in a thermoplastic and/or cross-linkable form and may optionally contain fillers.

The amounts of binder used for impregnation may vary depending on the desired barrier function. Preferably, the non-woven is impregnated with binder in an amount of 5% to 80%, preferably 10% to 70%, in each case based on the total weight of the non-woven.

In a further preferred embodiment of the invention, the non-woven is thermally strengthened. For this purpose, the non-woven may contain binding fibers, for example monofilament or bicomponent fibers. Preferably, the thermoplastic binding component of the binding fibers consists of polymers having a melting point at least 10° C., preferably at least 15° C., below the melting point of the matrix fibers. The proportion of the binding component is preferably 5-50 wt. %, more preferably 10-45 wt. %, in particular 15-40 wt. %, in each case based on the total weight of the non-woven. Particularly preferably, the binding component consists of (co)polyesters, polybutyleneterephthalate or (co)polyamides, in particular polyamide 6, or polyurethanes or polyolefins, in particular polyethylenes, as well as polypropylene and/or mixtures thereof. The binding fibers may be hydrophilic fibers within the meaning of the invention. The advantage of this is that they can increase the hydrophilicity of the non-woven. However, it is also conceivable to use non-hydrophilic binding fibers, for example polyolefins, instead of or in addition to hydrophilic binding fibers. In this embodiment, it is advantageous that the non-hydrophilic binding fibers counter penetration of the cover material into the non-woven.

To produce the non-woven, fibers may be laid in a wide range of manners known to the person skilled in the art. Thus, according to the invention, dry-laid non-wovens, wet non-wovens and/or spun non-wovens may be used.

Practical tests have shown that non-wovens having particularly good adhesive properties can be obtained if the non-woven is a wet non-woven. Further, wet non-wovens are distinguished in the use according to the invention in that they have a very dense, uniform structure and an isotropic fiber distribution. This is advantageous because it makes particularly uniform coating of the surface possible. It is additionally advantageous that mixtures of fibers can be used, in such a way that the structure and consistency of the surface can be selectively adjusted in a simple manner.

To produce the wet non-woven, short-cut fibers having a length in particular of 0.01 mm to 30 mm, preferably 0.01 to 25 mm, optionally mixed with further fibers, are preferably used. In a particularly preferred embodiment of the invention, fiber pulp, optionally in combination with other short-cut fibers, is used to produce the wet non-woven. The proportion of fiber pulp in the fiber mixture and/or in the non-woven is preferably 10-70 wt. %, more preferably 20-60 wt. %, in each case based on the total weight of the non-woven. In a preferred embodiment of the invention, the Schopper-Riegler grinding level of the fiber pulp is 10-60° SR, preferably 10-50° SR.

The fibrous web is laid in a known manner in that the fibers are initially dispersed to a high dilution in water and subsequently deposited on an inclined screen. Subsequently, the fibrous web is preferably thermally or chemically bonded.

As a result of the use according to the invention of a high proportion of fibers having a low fiber titer, it is possible to achieve a pore size distribution having a distribution maximum between 2.5-50 μm, preferably 2.5-40 μm, in particular 2.5-30 μm. The pore size distribution of the non-woven according to the invention, measured in accordance with ASTM E 1294, is thus preferably distinguished in that 80-100% of the pores have a diameter of 2.5-50 μm, preferably 2.5-40 μm, in particular 2.5-30 μm. Without limiting the invention to one mechanism, it is presumed that the particular pore size distribution significantly contributes to the good adhesive strength of the non-woven.

The pore size distribution of the non-woven is thus significantly influenced by the high proportion of the fibers having a fiber titer of less than 5 dtex, these fibers preferably being hydrophilic fibers. Practical tests have shown that particularly good adhesive strengths can be obtained if fibers having a fiber titer of 0.1 to 5 dtex, more preferably 0.1 to 4 dtex, in particular 0.1 to 3.3 dtex, are used. The hydrophilic fibers and/or the further fibers may have this fiber titer, it being preferred for the hydrophilic fibers to have this fiber titer.

In a particularly preferred embodiment of the invention, non-wovens are used which have a comparatively high packing density. The packing density is a non-woven property which is in inverse proportion to the porosity and/or the air permeability. In the non-woven, a high packing density goes together with a low air permeability or a low porosity. A high packing density or a low porosity and/or air permeability may for example be achieved in that the non-wovens are highly compacted by pressure and temperature.

The packing density a of a non-woven is defined as the ratio between the average volume of the solid forming the non-woven (solid body) and the volume of the non-woven, and is calculated as:

$$α = \frac{{m}_{non \text{-} woven} / {ρ}_{solid \text{-} body}}{{V}_{non \text{-} woven}} = \frac{{ρ}_{solid \text{-} body}}{{ρ}_{non \text{-} woven}}$$

α=packing density
ρ=average density of solid body or non-woven

Preferably, the non-wovens have a packing density of at least 0.1, preferably 0.12 to 0.8, more preferably 0.15 to 0.6, and/or an air permeability, measured in accordance with EN ISO 9237 at a pressure difference of 200 Pa, of at most 7000 l/m²s, preferably 1000 l/m²s to 2 l/m²s, more preferably 800 l/m²s to 20 l/m²s.

The use of non-wovens of this type has the advantage that, as compared with non-wovens of a higher porosity or air permeability, smaller amounts of cover material are required to achieve a uniform coating result. Otherwise, the non-woven may show through on the visible side.

To obtain as uniform a coating result as possible, it has further been found to be expedient to use non-wovens having a high smoothness. Particularly preferably, non-wovens are used which have a smoothness of at least 0.5 s in accordance with DIN 53107 at −48 kPa.

However, in particular non-wovens having a smoothness of 5 to 200 s, preferably 8 to 170 s, are preferred.

According to the invention, the proportion of fibers having a fiber titer of less than 5 dtex is at least 30 wt. %, based on the total weight of the non-woven. Preferably, the proportion of the fibers having a fiber titer of less than 5 dtex, 0.1 to 5 dtex, more preferably 0.1 to 4 dtex, more preferably 0.1 to 3.3 dtex, is 40 to 100 wt. %, more preferably 50 to 100 wt. %, in each case based on the total weight of the non-woven, these fibers preferably being hydrophilic.

The non-woven according to the invention is further distinguished by a short specific wetting time for water. This may be measured as follows under standard conditions (23° C., 1 bar): the non-woven sample to be tested is placed in the middle of a metal ring of 10 cm diameter. Care should be taken that the sample has an area of DIN A5 and the weight per unit area of the non-woven is in a range of 10-200 g/m². The thickness of the ring, in other words the distance between the non-woven and the support plane, should be selected in such a way that throughout the measurement time the non-woven has no contact with the surface positioned below, in other words is at least 0.3 cm. A drop of 50 μl demineralized water is now carefully placed in the middle of the sample (centered) using an Eppendorf pipette (application volume 20-200 μl, 200 μl pipette tips). On the one hand, care should be taken that the pipette tip does not touch the non-woven, in other words the drop is not injected into the non-woven. On the other hand, it is important that the drop is placed on the non-woven, in other words does not fall. The time required by the non-woven to absorb the water drop completely is now measured.

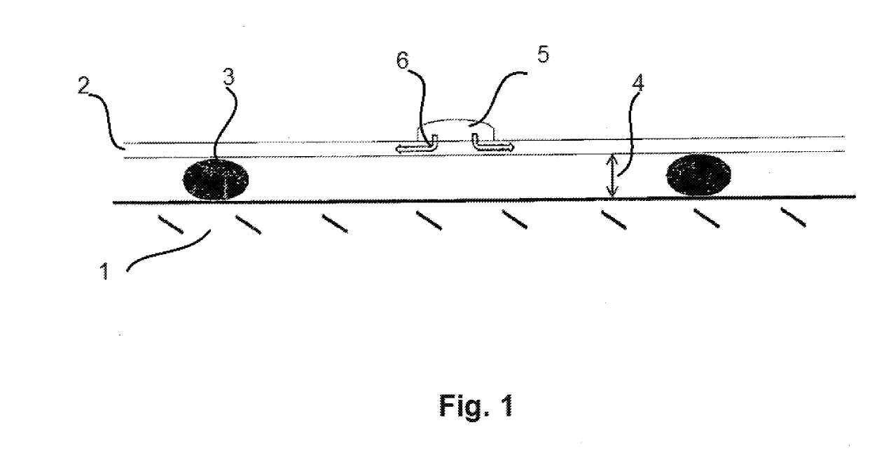

FIG. 1 shows an example of a test arrangement. In the drawing, reference numerals 1-6 denote the following:
1. work surface
2. non-woven
3. metal ring
4. distance between non-woven and work surface, at least 3 mm
5. water drop (50 μL)
6. water flow

Practical tests have shown that the non-wovens according to the invention make it possible, in the above-described procedure, to achieve wetting times of less than 20 min, preferably of less than 15 min, more preferably of less than 10 min. This shows that these non-wovens make particularly good adhesive strengths and a particularly uniform coating appearance possible.

The non-wovens according to the invention are preferably distinguished by a strength, measured in accordance with DIN ISO 9073-1, of at least 10 N/5 cm, preferably 10 N/5 cm to 400 N/5 cm to 400 N/5 cm, more preferably 20 N/5 cm to 300 N/5 cm and in particular 20 N/5 cm to 200 N/5 cm in the longitudinal direction.

The non-wovens according to the invention are further preferably distinguished by an expansion, measured in accordance with DIN ISO 9073-1, of 5% to 75%, preferably 5% to 70% and in particular 5% to 65% in the longitudinal direction.

The non-wovens according to the invention are further preferably distinguished by a tear propagation force in the longitudinal direction, measured in accordance with DIN 53356, of 0.1 to 30 N, preferably 0.2 N to 15 N.

To ensure that optimum adhesion comes about between the non-woven and the cover, it is advantageous for the non-woven to have a particular minimum thickness, so as to prevent penetration of the cover material into the non-woven. Good results are obtained in this regard with non-wovens having a thickness of 10 to 400 μm, preferably 10 to 250 μm and in particular between 10 and 100 μm. It has also been found to be advantageous for the non-woven to have a weight per unit area, measured in accordance with DIN ISO 9073-1, of 10 to 200 g/m², more preferably 10 to 150 g/m² and in particular 10-100 g/m².

When setting the average thickness (measured analogously with DIN 9073-2 for a contact area of 10 cm², a contact pressure of 1.25 kPa and a duration of 1 s) or weight per surface area of the non-woven, it should be taken into account that penetration of the cover material into the non-woven can also be countered by providing the non-woven with a high packing density or low porosity. This makes it possible to make the non-woven thinner, making more cost-effective manufacture possible.

Practical tests have shown that when a packing density in the range of 0.12 to 0.8 is set, comparatively thin products can be obtained, which have for example an average thickness in the range of 10 μm to 250 μm, in particular 10-100 μm, and with which good coating results can nevertheless be obtained.

In a further preferred embodiment of the invention, the materials for producing the non-woven are selected in such a way that it now merely has a low shrinkage, which is preferably less than 5%, measured at 200° C. (see Example 11). For this purpose, the use of aromatic polyesters for producing the non-woven has been found to be particularly suitable, in particular in combination with cellulose pulp.

As well as the hydrophilic fibers, the non-woven may also contain further non-hydrophilic fibers. As mentioned above, thermoplastic binder fibers, for example polyolefin, such as polyethylene or polypropylene, may be used as non-hydrophilic fibers. The non-hydrophilic fibers may for example be contained in the non-woven in an amount of 1 to 30% by weight, preferably 1 to 20% by weight and in particular 1 to 10% by weight, based on the total weight of the non-woven.

Depending on the provided use, the non-woven may be provided with a fire-proofing, fungicidal, insecticidal, biocidal, anti-corrosion, UV-protection, acid-protection and/or magnetic finish. It is likewise conceivable for the non-woven to be provided with a finish which increases the electromagnetic compatibility thereof and/or for it to be treated with a hydrophilising or hydrophobising agent. By way of a treatment with a hydrophilising or hydrophobising agent, the adhesion, attachment or absorbance of the cover can be selectively controlled by increasing or reducing the surface tension of the non-woven. However, in a preferred embodiment of the invention, the non-woven does not undergo pre-treatment, in particular treatment with an adhesion promoter and/or a wetting agent. Specifically, according to the invention it has been found that the non-woven according to the invention has excellent adhesion to a wide range of covers, in particular to varnish and/or paint layers, even without pre-treatment. Thus, according to the invention, it is possible to dispense with pre-treatment of the non-woven, making a simple, more cost-effective method possible.

It is also conceivable for the non-woven to undergo a fluorination, grafting, plasma, corona and/or flame treatment. Finally, it is also conceivable for the non-woven to be provided with a finish which acts as a barrier layer against escaping substances. Further, the non-woven and/or the cover may contain dyes and/or pigments for decorative purposes. These may also serve to reflect IR radiation. So as further or alternatively to reduce the heat penetration, hollow fibers or insulating additives such as aerogels may also be used.

As stated above, the non-woven according to the invention is outstandingly suitable as a carrier material for coating with a cover. Thus, a wide range of covers, for example varnish and/or paint layers, may be applied to the non-woven, and coating systems having good adhesion can be obtained. The cover materials may be applied in liquid or paste form and, as stated above, preferably be cured prior to the application of the coating system to surfaces to be protected.

Particularly decorative surfaces and good adhesions are achieved with the use of acrylate varnish, polyurethane varnish and/or mixtures thereof as a cover material.

According to the invention, radiation-curing varnishes, for example electron-beam and/or UV-crosslinkable varnishes, are preferred. Against this background, according to the invention the materials for producing the non-woven are preferably selected in such a way that they are stable against electron and/or UV beams. An advantage of the use of this varnish, as compared with water-based varnishes, is that as a result swelling of the base material and worsening of the strength properties thereof due to the water can be prevented.

Compared with powder varnishes, radiation-curable varnishes have the advantage that it is also possible to use substrates which are not electrically conductive. Further, the temperature load on the substrate is lower.

The thickness of the coating system may vary depending on the planned field of use. It is advantageous to keep to a minimum thickness of 0.01 mm to 0.5 mm, preferably 0.03-0.5 mm, so as to counter penetration of the cover material into the non-woven.

In a preferred embodiment of the invention, the coating system is applied to a carrier via the side remote from the coating, preferably after the curing of the cover. The term “curing of the cover” is used in the conventional sense, in other words to the effect that the cover material has fully reacted, for example been fully polymerised. Depending on the composition thereof, the cover may be cured in different ways, for example by air-drying or by electron-beam and/or UV and/or IR radiation.

To provide a good connection between the coating system and the carrier, it is advantageous for the side of the non-woven remote from the coating to be as free as possible of cover material. As stated above, this may for example be brought about in that a binder bonded or thermally bonded non-woven is used and/or in that the non-woven is impregnated with a binder.

In a further embodiment of the invention, a film, preferably provided with an adhesive layer, is used as a cover for the non-woven. For example, (co)polyesters, (co)polyamides, acrylates, polyurethanes, (partially saponified) polyvinylacetates or polyolefins may be used as the adhesive material and/or film material; particularly preferably, the film is applied to the non-woven directly, in other words without an adhesive layer. This may for example take place by extrusion coating. The thickness of the film is preferably 5 to 100 μm, particularly preferably 10 to 90 μm. An advantage of this embodiment is that the distribution of the adhesive material onto the non-woven surface provided with the cover is limited, and so the adhesion of the coating system to the carrier is not impeded.

To improve the adhesion between the coating system and the carrier, it may be advantageous for the non-woven to be provided, on the side remote from the cover, with an adhesive layer, preferably based on polyurethane. The adhesive layer may perform its adhesive functions as a thermoplastic layer and/or as a reactive layer, and be for example in the form of a powder, film or web. If a thermally reactivatable binder is used to bind the fibers, this property can be used so as to produce a self-adhesive coating system. Alternatively, for the fiber binding, a binder may be used which is inherently adhesive per se and thus leads to a self-adhesive coating system.

To protect the adhesive layer, it may be provided with a releasable protective layer, for example made of polyethylene and/or polypropylene and/or polyester. It is likewise conceivable for the cover applied to the non-woven to be provided with a protective layer. As a result, handling of the coating system without direct contact of the functional layers is made possible.

A wide range of materials may be used as carriers, for example wood, metal, PVC and/or GFRPs and CFRPs. Compared with direct application of the cover to the carrier, the use of the coating system has the advantage that the cover may already be cured when applied. This simplifies the handling of the coated materials, since for example varnish or paint layers are very sensitive to impacts or impurities when uncured. A further advantage is that, at the application site, the contamination of the atmosphere with solvents, which may be released when the cover dries, is reduced.

The non-woven may also be provided coated with a self-adhesive binder.

In the following, the invention is described in greater detail by way of embodiments.

### Example 1

### Production of a Non-Woven

To form the non-woven, monofilament and bicomponent polyolefin fibers are dispersed in a mixture in water and deposited as sheets using a hydroformer. The web is dried using a continuous flow dryer, at 90-120° C. depending on the melting range of the binding fibers. Calendering takes place at 90-100° C. and linear loads of 20-40 N/mm.

### Example 2

### Production of a Non-Woven

Calendered staple fiber non-wovens are produced from a mixture of monofilament PET and unstretched PET fibers. The fiber binding takes place at conventional temperatures between 205 and 235° C. and a pressure of 10 to 50 MPa.

### Examples 3-5

### Production of a Non-Woven

The web of examples 3-5 is created and deposited analogously with Example 1. Fiber mixtures of PET and cellulose pulp are used, which are additionally loaded with an acrylate binder. The drying temperatures are 150-210° C.; calendering takes place at 80-120° C. and linear loads of 160-200 N/mm.

### Example 6

### Production of a Non-Woven

Production takes place as described in Examples 3-5. Instead of monofilament PET, a sheath/core bicomponent fiber is used, of which the sheath polyester has a lower melting point than the core and is used for binding the fibers. The drying takes place at temperatures of 150-210° C.; calendering takes place at 185-215° C. and a linear load of 20-40 N/mm.

### Example 7

### Production of a Non-Woven

Calendered staple fiber non-wovens are produced from a mixture of monofilament viscose fibers and unstretched PET fibers. The fiber binding takes place at conventional temperatures between 205 and 235° C. and a pressure of 10 to 50 MPa.

### Example 8

### Production of a Non-Woven

A filament web is created from a polyester-polyamide bicomponent endless filament having a weight per unit area of 60 g/m² and undergoes water jet needling at pressures of 250 bar on each side. After the water jet needling, which leads to simultaneous splitting of the starting filaments, the bicomponent endless filaments have a titer of up to 0.1 dtex.

### Example 9

### Production of a Non-Woven

A filament web is created from a polyester-copolyester bicomponent endless filament having a weight per unit area of 50 g/m² and is smoothed by calendering at 140-170° C. and a linear load of 50-70 N/mm. The final fiber binding takes place at 190-220° C. in a thermal fusion furnace.

The surface energies of the fiber polymers used in the examples are as follows:

| Polymer | Surface energies [mN/mm]: |
|---|---|
| PE | 34 |
| PP | 29 |
| PET | 42 |
| PA 6,6 | 41 |
| PA 6 | 46 |
| Cellulose (cotton) | 42 |
| Cellulose (pulp) | 42-46 |

Table 1 gives characteristic values of the non-wovens used according to the invention.

TABLE 1
Property profile of embodiments

| | | | Tensile | | Tear | Air | Smoothness | Specific |
|---|---|---|---|---|---|---|---|---|
| | | | strength | Expansion | propagation | permeability | side 1/ | surface |
| | Weight | Thickness | MD | MD | force MD | @ 200 Pa | side 2 | area |
| Example | (g/m²) | [mm] | [N/5 cm] | [%] | [N] | [l/m²s²] | [s] | [m²/g] |
| 1 | 50 | 0.144 | 163.3 | 23.2 | 2.63 | 580 | 10/10 | 0.29 |
| 2 | 60 | 0.069 | 220 | 25 | 2.5 | 27 | 35/28 | 0.13 |
| 3 | 40 | 0.061 | 102.9 | 9.27 | 0.98 | 238 | 119/116 | 0.29 |
| 4 | 50 | 0.082 | 118.7 | 9.88 | 1.39 | 61 | 81/84 | 0.29 |
| 5 | 60 | 0.091 | 156.4 | 6.74 | 1.25 | 38 | 87/76 | 0.29 |
| 6 | 50 | 0.091 | 76 | 5 | 0.2 | 2 | 152/140 | 0.58 |
| 7 | 50 | 0.088 | 108 | 5 | 0.49 | 33 | 122/83 | 0.31 |
| 8 | 60 | 0.348 | 160 | 42.7 | 5.3 | 310 | 7 | 0.9 |
| 9 | 50 | 0.22 | 120 | 24 | 20 | 6163 | 0.5 | 0.25 |

| | Pore size range | | | | | |
|---|---|---|---|---|---|---|
| | [μm] | | | | | |
| | 1. smallest pore | Pore size | Wetting time | | | |
| | 2. largest pore | distribution | [s] | Shrinkage | | |
| | 3. mean flow | maximum | H2O | @ 200° C. | Packing | |
| Example | pore diam. | [μm] | [s/50 μl] | [%] | density | Adhesion |
| 1 | 1. 11.16 | 6-24 | >600 | 70.09 | 0.377 | poor |
| | 2. 51.34 | | | | | |
| | 3. 18.67 | | | | | |
| 2 | 1. 1.27 | 0.1-26 | >600 | 4.33 | 0.630 | poor |
| | 2. 36.34 | | | | | |
| | 3. 8.47 | | | | | |
| 3 | 1. 5.54 | 3-30 | 507 | 3.60 | 0.501 | good |
| | 2. 69.66 | | | | | |
| | 3. 15.17 | | | | | |
| 4 | 1. 2.89 | 3-15 | 184 | 4.00 | 0.465 | good |
| | 2. 37.98 | | | | | |
| | 3. 8.28 | | | | | |
| 5 | 1. 2.13 | 2.5-14 | 196 | 1.60 | 0.503 | good |
| | 2. 35.86 | | | | | |
| | 3. 7.26 | | | | | |
| 6 | 1. 1.8 | 2-10 | 21 | 1.80 | 0.382 | good |
| | 2. 20.6 | | | | | |
| | 3. 4.8 | | | | | |
| 7 | 1. 1.76 | 3-23 | 226 | 3.20 | 0.395 | good |
| | 2. 32.71 | | | | | |
| | 3. 8.32 | | | | | |
| 8 | 1. 5.29 | 6.5-15 | 2 | 4.60 | 0.138 | good |
| | 2. 25.72 | | | | | |
| | 3. 10.15 | | | | | |
| 9 | 1. 9.75 | 13-40 | 25* | 0.89 | 0.165 | good |
| | 2. 65.12 | | | | | |
| | 3. 17.46 | | | | | |

*Measured using 20 μl ethyleneglycol

### Example 10

### Varnish Adhesion Test

An electron-beam-crosslinkable varnish system based on polyurethane acrylates was used as a varnish, and crosslinked at a radiation dose of 30-50 kGy and a voltage of 220-270 kV.

The varnish adhesion (MD) is determined as follows: A non-woven is laminated onto the varnish coating using adhesive mass (sample size: DIN A4, microfiber spun non-woven, 130 g/m² using 25 g polycaprolactone adhesive mass). The lamination takes place at 80° C. and 1.4 bar over 30 s. A 5 cm strip of release paper is laid transverse to the longitudinal direction on the edge for simple separation. Subsequently, test strips (280 mm×50 mm) are punched out. To determine the adhesion, the coating is subsequently broken at the adhesion seam and the adhesion is determined in accordance with DIN 53357. If the varnish separates from the carrier non-woven at a separating force<5 N in the tension test, the adhesion is considered poor; if the separating force is >5 N, the adhesion is considered good.

As is shown in Table 1, Examples 1 and 2 have insufficient varnish adhesion. Considering the values shown in Table 1, Example 1 has a sufficient surface area and pore size distribution. Nevertheless, because of the construction from 100% hydrophobic olefin fibers, poor adhesion is found. If these are now replaced with more hydrophilic materials (Examples 3-5, 7), good varnish adhesion is achieved.

Example 2 is constructed from PET fibers having sufficient surface energy but a low surface area or having very small pores. If the surface energy is increased by mixing in cellulosic fibers (Example 8), good varnish adhesion is achieved in this case too. A further improvement is achieved by shifting the pore size distribution towards larger pores, or increasing the overall specific surface area.

### Example 11

### Shrinkage Measurement

A sample of the non-woven of DIN A4 size is taken. Care should be taken that the longer side of the sample is parallel to the machine direction. It is then stored in a circulation furnace at 200° C. for 30 s. The shrinkage results from the average of the change in mass along the two axes.

It has been found to be advantageous for the non-woven used to have the following properties:
during the production thereof, a sufficient amount of fibers having a low fiber titer are used,
the non-woven contains hydrophilic components having a surface energy of at least 35 mN/m, and
the specific surface area of the non-woven is at least 0.15 m², measured in accordance with DIN ISO 9277.

The high surface energy and high specific surface area of the non-woven can be achieved as disclosed above by suitably selecting the non-woven components. Non-wovens of this type make good adhesion of varnishes to the non-woven possible.

It is further advantageous for the pore size distribution of the non-woven in accordance with ASTM E 1294 to be such that 80-100% of the pores have a diameter of 2.5-50 μm, preferably 2.5-40 μm, in particular 2.5-30 μm. Without limiting the invention to one mechanism, it is presumed that the particular pore size distribution significantly contributes to the good adhesive strength of the non-woven. For a pore size distribution of this type, good wetting of the non-woven can be achieved, and makes the required penetration depth of the varnish system possible, and this in turn leads to satisfactory varnish adhesion. The interaction of the aforementioned factors may for example be characterized as disclosed above by way of the wetting time of the non-woven with water or ethylene glycol.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B, and C” should be interpreted as one or more of a group of elements consisting of A, B, and C, and should not be interpreted as requiring at least one of each of the listed elements A, B, and C, regardless of whether A, B, and C are related as categories or otherwise. Moreover, the recitation of “A, B, and/or C” or “at least one of A, B, or C” should be interpreted as including any singular entity from the listed elements, e.g., A, any subset from the listed elements, e.g., A and B, or the entire list of elements A, B, and C.

1. A multilayer, comprising a coating and a carrier material suitable for coating, the carrier material comprising a non-woven having a specific surface area of at least 0.15 m²,
wherein the non-woven comprises:
first fibers having a titer of less than 5 dtex in an amount of at least 30 wt. %, based on a total weight of the non-woven; and
a hydrophilic component comprising
second fibers having a surface energy of >35 mN/m,
a binder having a surface energy of >35 mN/m,
a filler having a surface energy of >35 mN/m, or
a mixture of two or more of any of these,
wherein the specific surface area is measured in accordance with DIN ISO 9277, and
wherein the surface energy is measured in accordance with DIN 55660.

2. The multilayer of claim 1, wherein a proportion of fibers having a titer of less than 5 dtex is 40-100 wt. %.

3. The multilayer of claim 1, the hydrophilic component comprises fibers comprising cellulose, viscose, Lyocell, (co)polyester, aliphatic (co)polyamide, aromatic (co)polyamide, aliphatic and aromatic (co)polyamide, polyphenylenesulfide, glass, basalt, polyurethane, polyimide, melamine resin, modacrylic, or polyacrylonitrile fibers, or a mixture of two or more of any of these.

4. The multilayer of claim 1, wherein a proportion of hydrophilic fibers in the non-woven is 20 wt. % to 100 wt. %, based on the total weight of the non-woven.

5. The multilayer of claim 1, comprising the binder,
wherein the binder comprises an acrylate, vinylacrylate, vinylacetate, ethylenevinylacetate (EVA), acrylonitrilebutadiene (NBR), styrenebutadiene (SBR), acrylonitrilebutadienestyrene (ABS), vinylchloride, ethylenevinylchloride, polyvinylalcohol, polyurethane, starch derivative, cellulose derivative, a copolymer thereof, or a mixture of two or more of any of these.

6. The multilayer of claim 1, wherein the second fibers are present in the hydrophilic component, and
wherein the second fibers have a titer of 0.1 to 5 dtex.

7. The multilayer of claim 1, wherein the second fibers are present in the hydrophilic component, and
wherein the second fibers are in the form of fiber pulp having a Schopper-Riegler grinding level of 10-60° SR.

8. The multilayer of claim 1, wherein the second fibers are present in the hydrophilic component, and
wherein the second fibers have an average fiber diameter, measured in accordance with DIN 53811, of 0.1 to 25 μm.

9. The multilayer of claim 1, wherein the non-woven has a specific wetting time for water of less than 20 min.

10. The multilayer of claim 1, wherein the non-woven has a thickness of 10 to 400 μm.

11. The multilayer of claim 1, wherein the non-woven is a wet non-woven.

12. The multilayer of claim 1, wherein the coating comprises a varnish, a paint, or a varnish and a paint layer.

13. A carrier, comprising the multilayer of claim 1.

14. A method for making the multilayer of claim 1, the method comprising:
combining the carrier material with a coating component.

15. A method of covering a surface, comprising at least indirectly contacting the surface with the multilayer of claim 1.

16. The multilayer of claim 1, wherein a proportion of fibers having a titer of less than 5 dtex is 50-100 wt. %.

17. The multilayer of claim 1, wherein a proportion of hydrophilic fibers having a titer of less than 5 dtex is 40-100 wt. %.

18. The multilayer of claim 1, wherein a proportion of hydrophilic fibers in the non-woven is 30 wt. % to 80 wt. %, based on a total weight of the non-woven.

19. The multilayer of claim 1, wherein the second fibers are present in the hydrophilic component, and
wherein the second fibers are in the form of fiber pulp having a Schopper-Riegler grinding level of 10-50° SR.

20. The multilayer of claim 1, wherein the second fibers are present in the hydrophilic component, and
wherein the second fibers have an average fiber diameter, measured in accordance with DIN 53811, of 1 to 25 μm
